(19) United States
(12) Patent Application Publication
(10) Pub. No.: US 2023/0305505 A1
(43) Pub. Date: Sep. 28, 2023

(54) CONTROL APPARATUS AND CONTROL METHOD

(71) Applicant: Isuzu Motors Limited, Yokohama-shi (JP)

(72) Inventors: Takuya KIKUCHI, Fujisawa-shi (JP); Futoshi YAMANE, Fujisawa-shi (JP)

(73) Assignee: Isuzu Motors Limited, Yokohama-shi (JP)

(21) Appl. No.: 18/124,011

(22) Filed: Mar. 21, 2023

(30) Foreign Application Priority Data
Mar. 23, 2022 (JP) 2022-047134

(51) Int. Cl. G05B 19/042

(52) U.S. Cl. CPC G05B 19/042; G05B 2219/2639

(57) ABSTRACT

A control apparatus and a control method are capable of preventing an erroneous protection operation from being performed. The control apparatus includes a plurality of detection sections each detecting the state of one of a plurality of batteries connected to an external load, a determination section that determines whether a detection result of each of the detection sections is valid, and a control section configured to control so as to perform a protection operation based on a determination result of the determination section. The determination section determines the validity of the detection result by comparing the detection results of the plurality of detection sections with one another, for example.

### CROSS REFERENCE TO RELATED APPLICATIONS

This application claims the benefit of priority of Japanese Patent Application No. 2022-047134 filed on Mar. 23, 2022, the contents of which are incorporated by reference as if fully set forth herein in their entirety.

### TECHNICAL FIELD

The present disclosure relates to a control apparatus and a control method.

### BACKGROUND ART

For example, a temperature sensor has been developed to use as a state detection section that detects the state of a secondary battery.

PTL 1 describes a control apparatus that performs protection operation control to block a charging path for charging from a charger to a secondary battery when a temperature sensor detects a predetermined temperature.

### CITATION LIST

### Patent Literature

### PTL 1

Japanese Patent Application Laid-Open No. 2004-135424

### SUMMARY OF INVENTION

### Technical Problem

In the control apparatus described in PTL 1, if the temperature sensor is damaged and cannot correctly detect the state of the secondary battery, there is a risk that an erroneous protection operation is performed on the basis of an erroneous detection result.

Accordingly, the present disclosure provides a control apparatus and a control method capable of preventing an erroneous protection operation from being performed.

### Solution to Problem

In order to achieve the abovementioned object, a control apparatus in the present disclosure includes:
a plurality of detection sections each configured to detect a state of one of a plurality of batteries connected to an external load;
a determination section configured to determine whether a detection result of each of the detection sections is valid; and
a control section configured to perform control so as to perform a protection operation based on a determination result of the determination section.

A control method in the present disclosure, includes:
detecting a state of each of a plurality of batteries connected to an external load;
determining whether a detection result of the state is valid; and
performing control so as to perform a protection operation based on a determination result as to whether the detection result is valid.

### Advantageous Effects of Invention

According to the present disclosure, it is possible to prevent an erroneous protection operation from being performed.

### BRIEF DESCRIPTION OF DRAWINGS

FIG. 1 illustrates the configuration of a control apparatus according to an embodiment of the present disclosure; and

FIG. 2 is a flowchart of an example of a control method according to an embodiment of the present disclosure.

### DESCRIPTION OF EMBODIMENTS

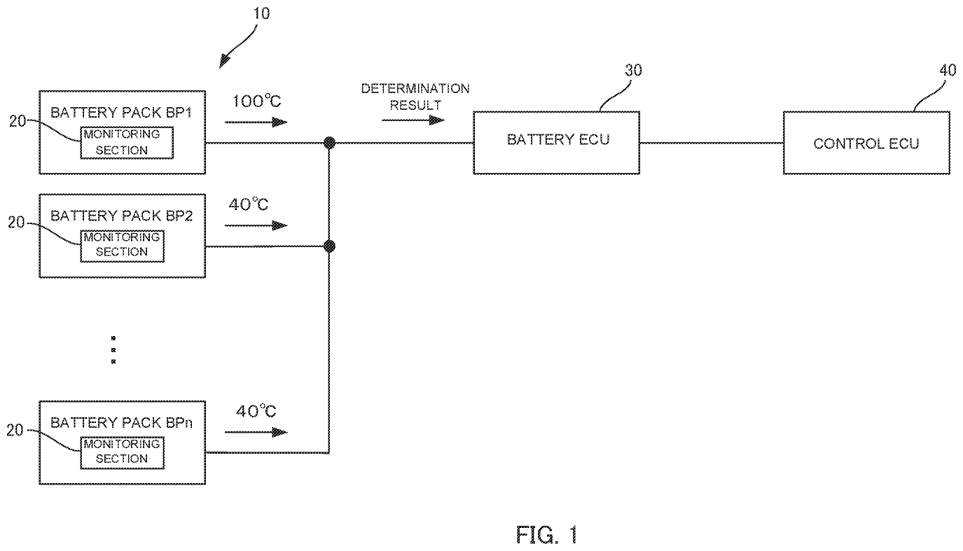

Embodiments of the present disclosure are described below with reference to the accompanying drawings. FIG. 1 illustrates the configuration of control apparatus 10 according to an embodiment of the present disclosure. Control apparatus 10 includes plurality of battery packs BP. Control apparatus 10 is mounted in a vehicle. An assembled battery is configured by plurality of battery packs BP. Plurality of battery packs BP are connected to an external load via a power supply circuit (not illustrated). FIG. 1 illustrates n battery packs BP1, BP2, . . . , BPn, where n is an integer greater than or equal to 2.

Control apparatus 10 includes monitoring section 20, battery ECU 30 (corresponding to a “control section” of the present disclosure), and control ECU 40.

[Monitoring Section 20]

Monitoring section 20 is mounted in each of battery packs BP. Monitoring section monitors and controls battery pack BP. Monitoring section 20 includes a central processing unit (CPU), a read only memory (ROM), a random access memory (RAM), and the like.

Monitoring section 20 is provided in each of battery packs BP. Monitoring section has a function (corresponding to a “detection section” of the present disclosure) of detecting the state of battery pack BP, such as the temperature of battery pack BP and the voltage of battery pack BP.

Monitoring section 20 further has a function (corresponding to a “determination section” of the present disclosure) of determining whether the detection result obtained by detecting the state of battery pack BP is valid. The determination result of the determination section is transmitted to battery ECU 30.

[Battery ECU 30]

Battery ECU 30 includes a central processing unit (CPU), a read only memory (ROM), a random access memory (RAM), and the like. The CPU reads a program corresponding to a process to be performed from the ROM, loads the program into the RAM, and performs a predetermined function of battery ECU 30 in accordance with the loaded program. At this time, a variety of data stored in a storage section (not illustrated) are referenced. The storage section is composed of, for example, a nonvolatile semiconductor memory (known as a flash memory) or a hard disk drive. Battery ECU 30 may be incorporated into, for example, a vehicle electronic control unit (ECU) that controls each part of a vehicle. Alternatively, battery ECU 30 may be configured integrally with control ECU 40 or may be provided separately from the vehicle ECU and control ECU 40.

Battery ECU 30 acquires the determination result as to whether the detection result of the detection section is valid. Even if the detection result indicates a malfunction of battery pack BP, battery ECU 30 performs control so as not to perform the protection operation as long as it is determined that the detection result is not valid. That is, if it is determined that battery pack BP malfunctions and it is determined that the detection result is valid, battery ECU 30 performs control so as to perform a protection operation.

A particular example of the control performed by battery ECU 30 is described below with reference to FIG. 1. FIG. 1 illustrates the temperature information for battery packs BP, where the detection results from battery packs BP1, BP2, . . . , BPn are “100° C.”, “40° C.”, . . . , “40° C.”, respectively. Note that the detection result “100° C.” is an abnormal value indicating that battery pack BP malfunctions. The detection result “40° C.” is a normal value indicating that battery pack BP is normal. In this case, even if monitoring section 20 of battery pack BP1 detects that battery pack BP1 malfunctions, battery ECU 30 performs control so as not to perform protection operation as long as it is determined that the detection result “100° C.” is not valid.

According to the present embodiment, examples of a “protection operation” include a protection operation to disconnect battery pack BP from the power supply circuit, a protection operation to temporarily activate electrical equipment connected to battery pack BP, a protection operation to limit charging/regenerating of battery pack BP, and a protection operation to limit the power of a vehicle.

Battery ECU 30 and control ECU 40 are connected by a CAN bus. When the protection operation is performed, control information is transmitted from battery ECU 30 to control ECU 40.

[Control ECU 40]

Control ECU 40 includes a central processing unit (CPU), a read only memory (ROM), a random access memory (RAM), and the like. The CPU reads a program corresponding to a process to be performed from the ROM, loads the program into the RAM, and performs a predetermined function of control ECU 40 in accordance with the loaded program. At this time, a variety of data stored in a storage section (not illustrated) are referenced. The storage section is composed of, for example, a nonvolatile semiconductor memory (known as a flash memory) or a hard disk drive. For example, control ECU 40 may be incorporated into a vehicle electronic control unit (ECU) that controls each part of the vehicle. Alternatively, control ECU 40 may be configured integrally with battery ECU or may be provided separately from the vehicle ECU and battery ECU 30.

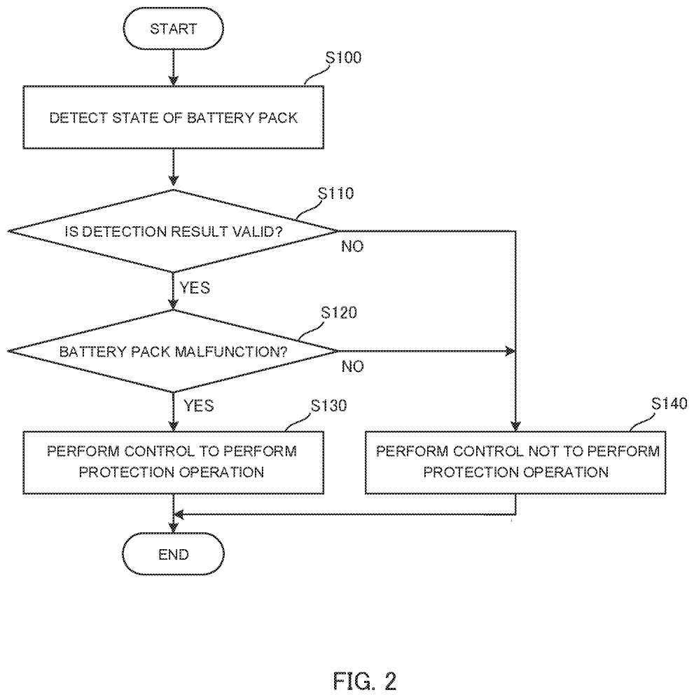

An example of the control method according to an embodiment of the present disclosure is described below with reference to FIG. 2. FIG. 2 is a flowchart of the example of the control method according to the embodiment of the present disclosure. The flow is started by, for example, a key operation (or a start operation) performed by a user and, thereafter, the flow is repeated at predetermined time intervals. Note that although each of the steps illustrated in FIG. 2 is performed through, for example, the function of monitoring section 20 or battery ECU 30, the steps are described herein as being performed by the CPU of monitoring section 20 or battery ECU 30.

In step S100, the CPU detects the state of battery pack BP first.

Subsequently, in step S110, the CPU determines whether the detection result obtained by detecting the state of battery pack BP is valid. If the detection result is valid (step S110: YES), the processing proceeds to step S120. If the detection result is not valid (step S110: NO), the processing proceeds to step S140.

In step S120, the CPU determines whether the detection result indicates a malfunction of battery pack BP. If the detection result indicates a malfunction of battery pack BP (step S120: YES), the processing proceeds to step S130. If the detection result does not indicate a malfunction of battery pack BP (step S120: NO), the processing proceeds to step S140.

In step S130, the CPU performs control so as to perform a protection operation. Thereafter, the flow ends.

In step S140, the CPU performs control so as not to perform a protection operation. Thereafter, the flow ends.

Control apparatus 10 according to the embodiment of the present disclosure includes a plurality of detection sections each detecting the state of one of the plurality of battery packs connected to an external load, a determination section that determines whether the detection result of the detection section is valid, and a control section that performs control to perform a protection operation on the basis of the determination result of the determination section.

According to the above-described configuration, even if it is detected that battery pack BP malfunctions, the protection operation is not performed as long as it is determined that the detection result is not valid. This prevents an erroneous protection operation from being performed.

In addition, in control apparatus 10 according to the above-described embodiment, monitoring section 20 determines whether the detection result is valid. However, the present disclosure is not limited thereto. For example, battery ECU 30 may make the determination. In this case, battery ECU 30 determines whether the detection result is valid by comparing the detection results of plurality of monitoring sections 20 with one another. For example, battery ECU 30 determines that the detection result “100° C.” is not valid by comparing the detection result “100° C.” with the detection results “40° C.” illustrated in FIG. 1. This makes it possible to improve the determination accuracy when the validity of the detection result is determined.

In addition, in control apparatus 10 according to the above-described embodiment, battery ECU 30 performs control to perform a protection operation. However, the present disclosure is not limited thereto. For example, when communication between monitoring section 20 and battery ECU 30 is not possible, monitoring section 20 may perform control to perform a protection operation.

In addition, while control apparatus 10 according to the above-described embodiment has been described with reference to the temperature of battery pack BP as an example of the state of battery pack BP, the present disclosure is not limited thereto. For example, the voltage of battery pack BP may be used as the state of battery pack BP. Furthermore, the malfunction of battery pack BP may include a malfunction other than the malfunction of the detection section. In addition, when a subset of monitoring sections 20 transmits an abnormal value, the abnormal value from the transmission source may be excluded (that is, the abnormal value is not transmitted to battery ECU 30 in the upper layer), or an operation to submit a request for disconnection from the circuit may be performed. In addition, in control apparatus 10 according to the above-described embodiment, battery packs BP are to be protected. However, if the battery pack includes a plurality of battery cells, the battery cells may be protected.

In addition, the above-described embodiments are merely examples of specific implementations of the present disclosure, and the technical scope of the present disclosure should not be construed to be limited by the embodiments. That is, the present disclosure can be embodied in various forms without departing from the spirit or essential characteristics thereof.

### INDUSTRIAL APPLICABILITY

The present disclosure is suitably used for vehicles equipped with a control apparatus that is required to prevent an erroneous protection operation from being performed.

### REFERENCE SIGNS LIST

BP, BP1, BP2, . . . , BPn Battery pack
10 Control apparatus
20 Monitoring section
30 Battery ECU
40 Control ECU

1. A control apparatus, comprising:
a plurality of detection sections each configured to detect a state of one of a plurality of batteries connected to an external load;
a determination section configured to determine whether a detection result of each of the detection sections is valid; and
a control section configured to perform control so as to perform a protection operation based on a determination result of the determination section.

2. The control apparatus according to claim 1, wherein the determination section determines whether the detection result is valid by comparing the detection results of the plurality of detection sections with one another.

3. A control method, comprising:
detecting a state of each of a plurality of batteries connected to an external load;
determining whether a detection result of the state is valid; and
performing control so as to perform a protection operation based on a determination result as to whether the detection result is valid.
